(19) United States
(12) Patent Application Publication
(10) Pub. No.: US 2025/0389890 A1
(43) Pub. Date: Dec. 25, 2025

(54) OPTICAL DEVICES WITH INTERLAYER WAVEGUIDE STRUCTURES

(71) Applicant: Applied Materials, Inc., Santa Clara, CA (US)

(72) Inventors: Guannan Chen, Belmont, CA (US); Elise Laffosse, Santa Clara, CA (US); Zijiao Yang, Fremont, CA (US); Jinxin Fu, Santa Clara, CA (US)

(21) Appl. No.: 19/192,624

(22) Filed: Apr. 29, 2025

Related U.S. Application Data
(60) Provisional application No. 63/663,377, filed on Jun. 24, 2024.

(51) Int. Cl. G02B 6/122; G02B 6/13

(52) U.S. Cl. CPC G02B 6/122; G02B 6/13

(57) ABSTRACT

A system includes an optical device. The optical device includes a first device section corresponding to a first metallization level including at least a first conductive line located at a first plane, a second device section corresponding to a second metallization level including at least a second conductive line located at a second plane different from the first plane, and a first waveguide including a first inner core located at a third plane between the first plane and the second plane.

### CROSS-REFERENCE TO RELATED APPLICATION(S)

The present application claims the benefit of U.S. Provisional Patent Application No. 63/663,377, filed on Jun. 24, 2024, the entire contents of which are hereby incorporated by reference herein.

### TECHNICAL FIELD

Embodiments of the present disclosure relate to optical devices, and more particularly to optical devices with interlayer waveguide structures, such as optical interconnects (e.g., interposers) and/or photonic integrated circuits (PICs) of co-packaged optical devices.

### BACKGROUND

In an optical system, an optical signal can travel through a waveguide (e.g., optical fiber) that is formed from an inner core made of a first material having a first index of refraction and an outer cladding structure made of a second material having a second index of refraction less than the first index of refraction. For example, the first material and the second material can each be formed from a different type of glass. The cladding structure helps to confine optical signals within the inner core by total internal reflection, reduce signal loss due to scattering and absorption, and provide protection for the inner core. Thus, when an optical signal traveling in a waveguide is incident on the boundary between the inner core and the cladding structure at an angle exceeding the critical angle, the optical signal can exhibit total internal reflection.

### SUMMARY

In some embodiments, a system is provided. The system includes an optical device. The optical device includes a first device section corresponding to a first metallization level including at least a first conductive line located at a first plane, a second device section corresponding to a second metallization level including at least a second conductive line located at a second plane different from the first plane, and a first waveguide including a first inner core located at a third plane between the first plane and the second plane.

In some embodiments, a method is provided. The method includes forming, on a base structure of an optical device, a first cladding layer. The base structure includes a first device section corresponding to a first metallization level of the optical device. The method further includes forming, on the first cladding layer, a first inner core of a first waveguide, forming, on the first inner core and the first cladding layer, a second cladding layer to form a first cladding structure of the first waveguide, and forming, within the first cladding structure, a second device section corresponding to a second metallization level of the optical device.

Numerous other aspects and features are provided in accordance with these and other embodiments of the disclosure. Other features and aspects of embodiments of the disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-1B are diagrams of views of example systems that can implement optical devices with interlayer waveguide structures, according to some embodiments.

FIGS. 2A-2E are diagrams of example optical devices with interlayer waveguide structures, according to some embodiments.

FIGS. 3A-3F are diagrams illustrating the fabrication of an example optical device with an interlayer waveguide structure, according to some embodiments.

FIGS. 4A-4F are diagrams illustrating the fabrication of an example optical device with an interlayer waveguide structure, according to some embodiments.

FIGS. 5-7 are flowcharts of example methods to fabricate optical devices with interlayer waveguide structures, according to some embodiments.

### DETAILED DESCRIPTION

Embodiments of the present disclosure relate to optical devices with interlayer waveguide structures. A co-packaged device (e.g., multi-chip module) can include a package substrate having multiple PICs assembled closely together. More specifically, optical components can be integrated on substrates (e.g., silicon (Si) substrate) for fabricating large-scale PICs that co-exist with micro-electronic chips. With the use of an optical transceiver, a received optical signal can be converted to an electrical signal capable of being processed by an integrated circuit, or the processed electrical signal can be converted to an optical signal to be transmitted via an optical fiber.

Instead of ICs (e.g., microchips) that utilize electrons to process information, referred to as electronic ICs (EICs), a PIC utilizes photons (light particles) to process information. A PIC can include multiple photonic components connected on a single chip. Examples of components of a PIC include optical signal generators (e.g., lasers) to generate optical signals (e.g., light), waveguides to direct optical signals within the PIC (e.g., similar to wires used to direct electrons), modulators to modulate optical signals to encode information, and detectors to detect and decode the information from the optical signals. PICs can have various advantages over EICs. For example, PICs can offer high data rates due to the high speed performance capabilities of the integrated photonic components such as the optical modulator and detector. As another example, photons within PICs can experience less signal loss as compared to electrons within EICs, which enables more energy-efficient operation.

A co-packaged device can include an optical interconnect disposed between a first component and a second component. For example, an optical interconnect can be a placed between a package substrate and a ball grid array. In some embodiments, an optical interconnect includes an interposer. An interposer is an electrical interface that routes connections between sockets or connections between the first component and the second component. An interposer can be used to connect components that may not naturally connect to one another. Some optical interconnects (e.g., interposers) can include multiple conductive layers (e.g., metal layers), where pairs of conductive layers are connected by at least one conductive via (“via”). For example, a first conductive layer of a first metallization level and a second conductive layer of a second metallization level can be connected by at least one via. Some optical interconnects (e.g., interposers) can further include multiple waveguides integrated near the conductive layers.

The waveguides of an optical interconnect can use evanescent wave coupling to transmit an optical signal received from an initial waveguide of the optical interconnect to a final waveguide of the optical interconnect. For example, the initial waveguide can be integrated near a bottom conductive layer of the optical interconnect, and the final waveguide can be integrated near a top conductive layer of the optical interconnect. Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling can occur when an evanescent wave generated within a waveguide excites an electromagnetic wave in an adjacent waveguide. Evanescent wave coupling can be accomplished when two waveguides are positioned close together such that the evanescent field generated by one of the waveguides reaches the other waveguide before any substantial decay of the evanescent wave is experienced. Generally, an evanescent wave is an oscillating wave (e.g., electromagnetic wave or acoustic wave) generated at a boundary between two media and exists only within a very short distance from the boundary. Evanescent waves can exit the waveguide, and their amplitude can decay exponentially as a function of distance from the boundary. Thus, evanescent waves are generally observable in the near field of the optical signal in close proximity to the boundary.

Waveguides have been widely adopted and optimized in optical device (e.g., PIC) applications. Waveguides used in optical devices can be formed from any suitable material. Examples of materials include silicon nitride (SiₓN_{y}) (or SiN), lithium niobate (LiNbO₃), gallium arsenide (GaAs), indium phosphide (InP), etc. For example, properties of waveguides such as low loss, transparency over wide spectrum, high optical power handling capacity, mode confinement, and complementary metal-oxide semiconductor (CMOS) foundry process compatibility can increase data rates and signal bandwidth for datacenters, driven by recent surge of artificial intelligence generated content (AIGC) model training and inference such as large language models (LLMs).

Some films (e.g., SiN films) in PIC foundries have a ubiquitous low propagation loss requirement. The loss is related to how the film is deposited, treated, and processed in the device process flow. Some process tools of an electronic device manufacturing system can perform high thermal budget processes, such as low pressure chemical vapor deposition (LPCVD), high temperature annealing, etc. Such high thermal budget processes can impact when a waveguide can be formed within a process flow for fabricating the optical device, such as prior to formation of optical interconnects during a back end of line (BEOL) process of the process flow.

Aspects and implementations described herein can address these and other drawbacks by implementing optical devices with interlayer waveguide structures. An optical device described herein can include inner cores of waveguides that are designed to be placed between conductive lines (e.g., metal layers) of interconnect structures formed during the BEOL process (“interlayer waveguides”). For example, an interconnect structure can include a conductive line coupled to a via. An inner core of waveguide described herein can be formed by depositing an inner core material using a low loss deposition process. One example of a suitable inner core material is SiN. The low loss deposition process can be a low temperature deposition process that is compatible with the thermal budget of the interconnect structures (e.g., performed at a temperature of less than or equal to about 400° C.) in order to form inner cores of waveguides between the conductive lines during BEOL processing. In some embodiments, the low loss deposition process is a plasma-enhanced chemical vapor deposition (PE-CVD) process performed at a temperature of less than or equal to about 400° C. Accordingly, an inner core of a waveguide described herein can be formed using a low loss deposition process performed during and/or after BEOL processing.

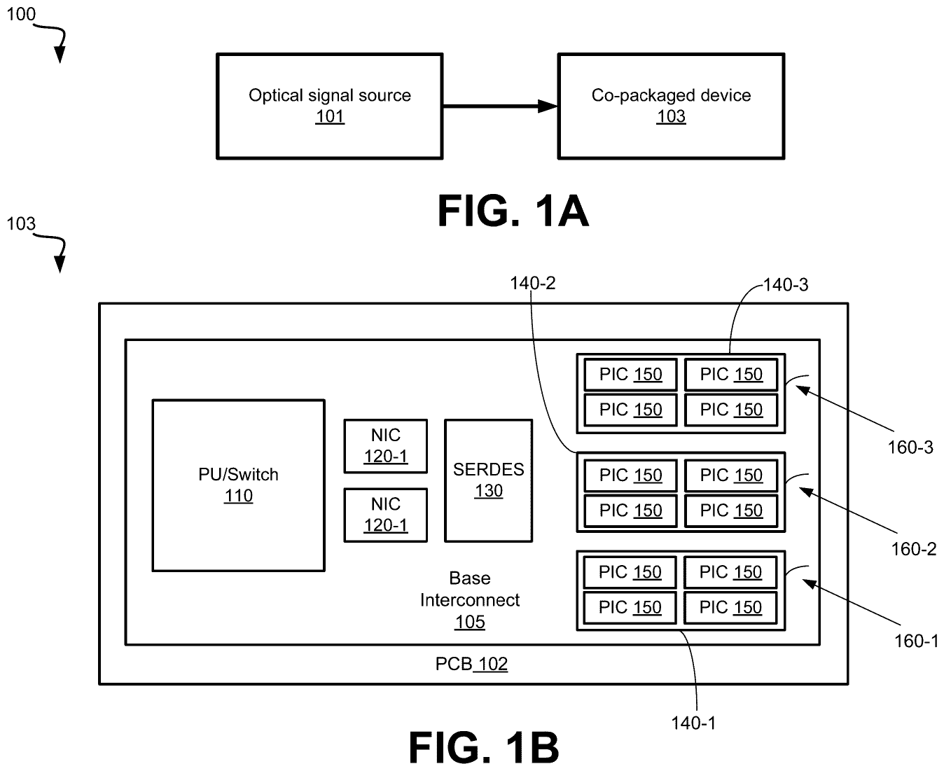

In some embodiments, an optical device is a PIC. In some embodiments, an optical device is an optical interconnect (e.g., interposer). In some embodiments, a first optical device and a second optical device are bonded using hybrid bonding to form a hybrid bonded optical device. Optical signals can be transferred between the first optical device and the second optical device using evanescent coupling. Hybrid bonding refers to bonding that includes both conductive material (e.g., metal) and dielectric at the interfaces. Hybrid bonding can enable high speed (e.g., greater than or equal to 100 gigabits (Gbs)/channel) optical and electrical connectivity between the optical interconnect and the PIC. Further details regarding implementing optical devices with interlayer waveguide structures are described below with reference to FIGS. 1A-6.

Embodiments described herein can provide for numerous other technical advantages. For example, embodiments described herein can improve optical device manufacturing efficiency by enabling the formation of inner cores of waveguides during and/or after BEOL processing.

FIG. 1A is a block diagram of system 100, according to some embodiments, As shown, the system 100 can include optical signal source 101 and co-packaged device 103. Optical signal source 101 can provide, as input to co-packaged device, multiple wavelengths of optical signals (e.g., multiple wavelengths of light). For example, optical signal source 101 can include multiple optical signal generators (e.g., lasers) that each generate a respective wavelength of an optical signal. An example of co-packaged device 103 will now be described below with reference to FIG. 1B.

FIG. 1B is a block diagram of a top-down view of co-packaged device 103, according to some embodiments. As shown in FIG. 1B, co-packaged device 103 can include printed circuit board (PCB) 102, base optical interconnect (e.g., interposer) 105, at least one processing unit and/or switch (PU/switch) 110 formed on base optical interconnect 105, at least one network interface card (NIC) 120 formed on base optical interconnect 105, serializer-deserializer (SERDES) 130 formed on base optical interconnect 105, multiple optical interconnects 140-1 through 140-3 formed on base optical interconnect 105, multiple photonic integrated circuits (PICs) 150 formed on each of optical interconnects 140-1 through 140-3, and multiple waveguides 160-1 through 160-3 each coupled to a respective one of optical interconnects 140-1 through 140-3. In some embodiments, and as shown, the number of optical interconnects is three. However, the number of optical interconnects should not be considered limiting. In some embodiments, and as shown, each set of PICs 750s includes four PICs. However, the number of PICs should not be considered limiting. More specifically, each of optical interconnects 140-1 through 140-3 can be disposed between respective sets of PICs 150 and base optical interconnect 105.

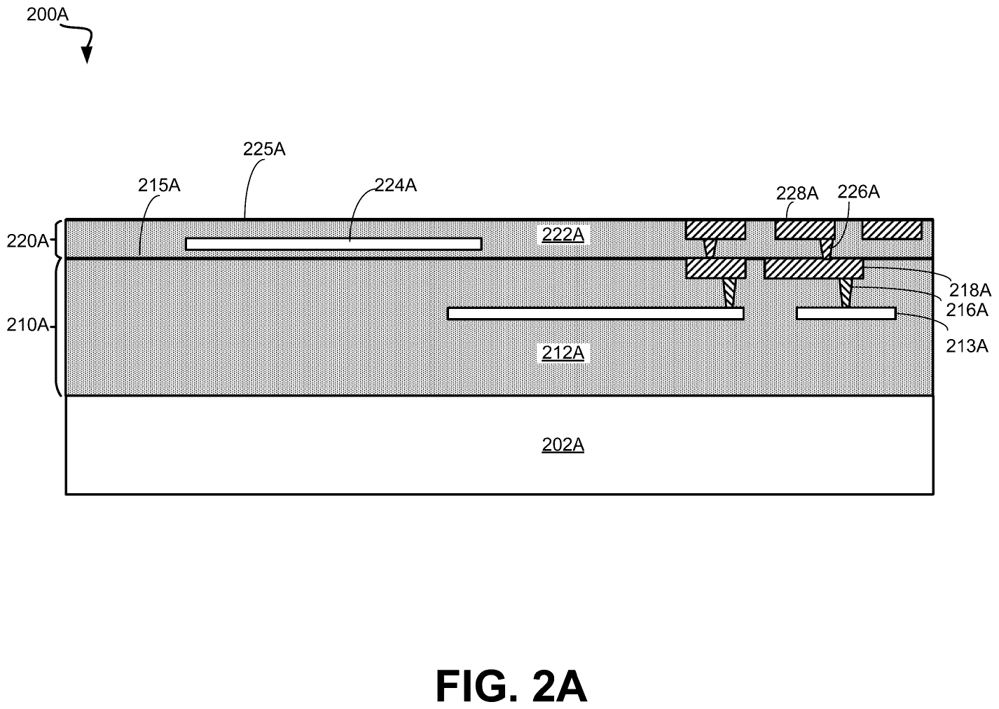

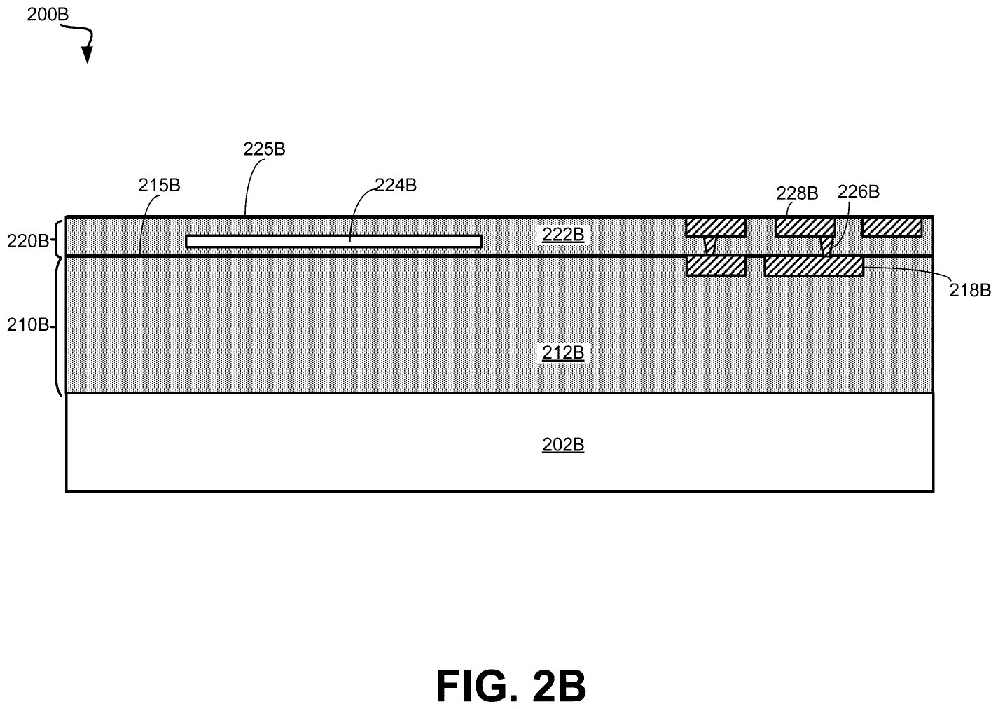

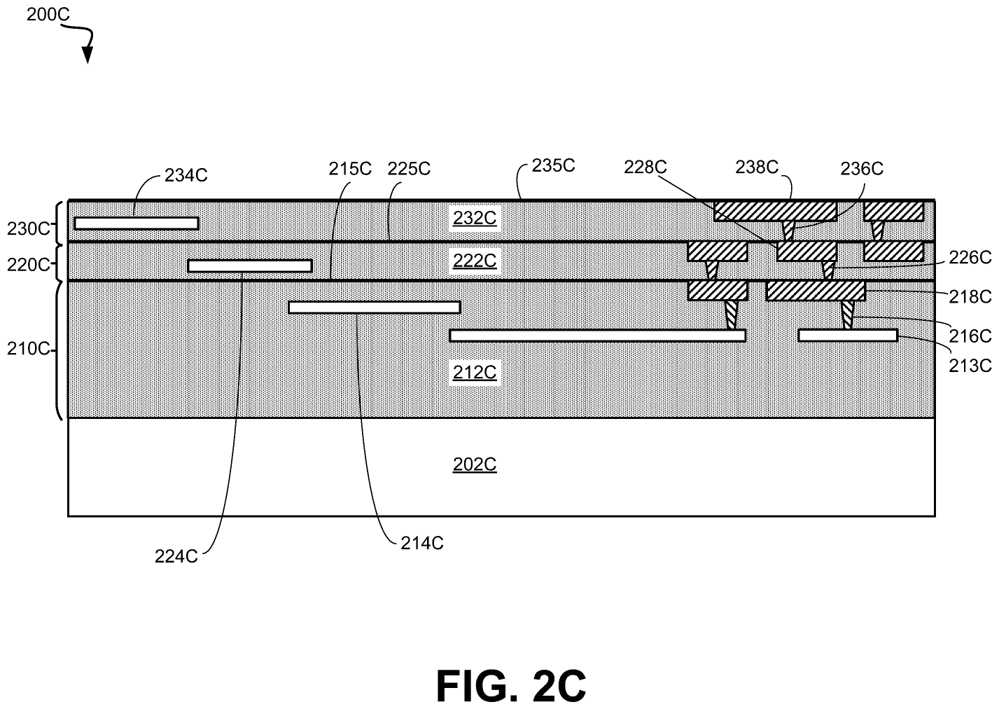

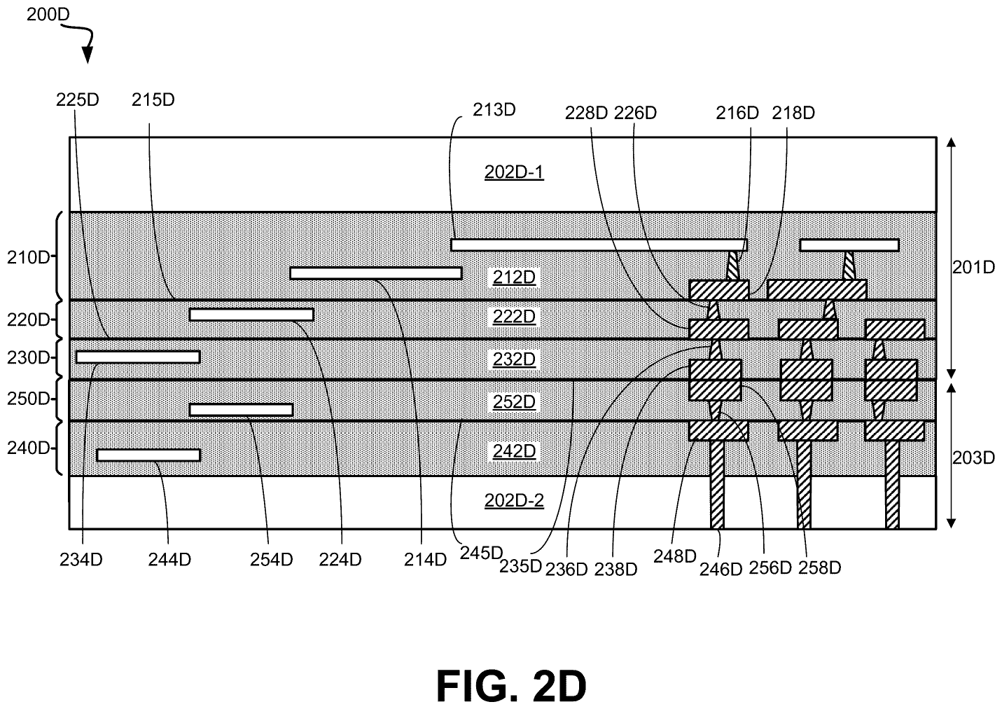

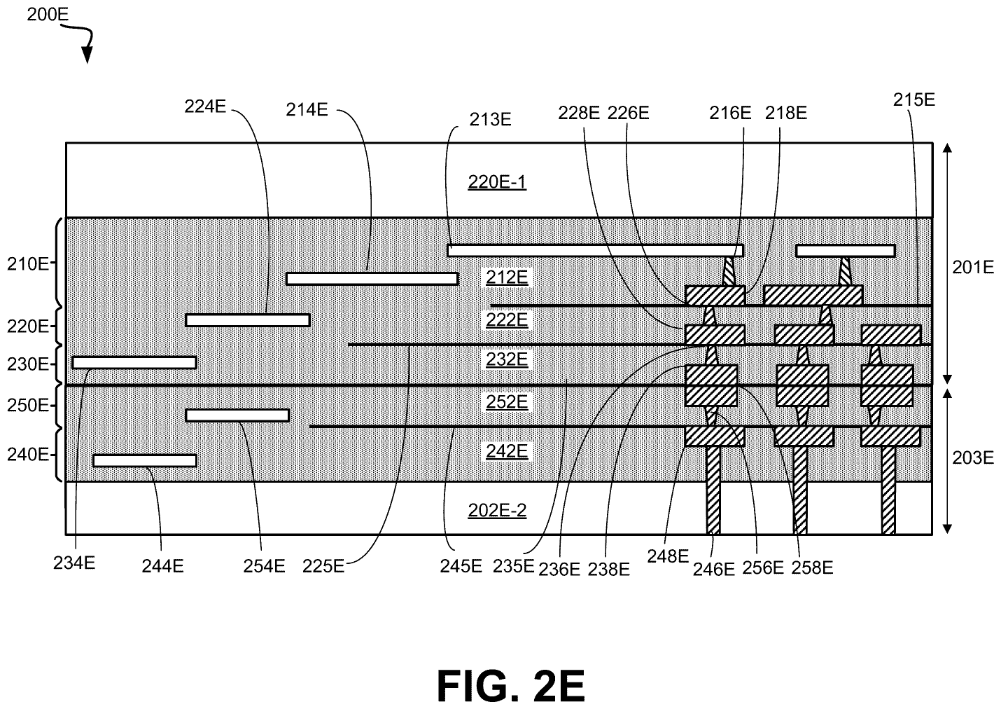

FIG. 2A is a cross-sectional view of an optical device (“device”) 200A, according to some embodiments. As shown in FIG. 2A, the device 200A includes a substrate 202A. The substrate 202A can include any suitable material. Examples of suitable materials include silicon (Si), silicon-germanium (SiGe), glass, etc.

The device 200A can further include a device section 210A formed on the substrate 202A. The device section 210A can include a dielectric layer 212A. The dielectric layer 212A can be formed from any suitable material. In some embodiments, the dielectric layer 212A is formed from oxide. For example, the dielectric layer 212A can be formed from silicon dioxide (SiO₂). The device section 210A can further include a set of inner cores of waveguides, including an inner core 213A formed in the dielectric layer 212A. The set of waveguides including the inner core 213A can be formed from any suitable material. In some embodiments, the inner core 213A is formed from Si. The device section 210A can further include a first metallization level of the device 200A. The first metallization level includes a first set of interconnect structures formed in the dielectric layer 212A, where each interconnect structure of the first set of interconnect structures is coupled to a respective inner core of the set of inner cores of the device section 210A. For example, each interconnect structure of the first set of interconnect structures can include a via coupled to a conductive line, such as a via 216A coupled to a conductive line 218A. The via 216A is also coupled to the inner core 213A. Each interconnect structure of the first set of interconnect structures (e.g., via and conductive line) can be formed from any suitable conductive material. Examples of suitable conductive materials include copper (Cu), tungsten (W), aluminum (Al), silver (Ag), gold (Au), molybdenum (Mo), titanium (Ti), tantalum (Ta), etc. In some embodiments, the substrate 202A and the device section 210A form a base structure of the device 200A.

The device 200A can further include a device section 220A formed on the device section 210A. The device section 220A can include a waveguide including a cladding structure 222A surrounding an inner core 224A. The cladding structure 222A can be formed from any suitable material. In some embodiments, the cladding structure 222A is formed from oxide. For example, the cladding structure 222A can be formed from SiO₂. In some embodiments, the dielectric layer 212A is formed from the same material as the cladding structure 222A. In some embodiments, the dielectric layer 212A and the cladding structure 222A are formed from different materials. More specifically, the inner core 224A can be formed by depositing an inner core material using a low loss deposition process. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. The inner core 224A can be formed from any suitable material. One example of a suitable inner core material is SiN.

Accordingly, the inner core 224A can be formed from a different material than the inner core 213A. The device section 220A can further include a second metallization level of the device 200A including a second set of interconnect structures formed in the cladding structure 222A. For example, at least two interconnect structures of the second set of interconnect structures can each include a respective via coupled to a respective conductive line, such as a via 226A coupled to a conductive line 228A. The via 226A is also coupled to the conductive line 218A. Each interconnect structure of the second set of interconnect structures (e.g., via and/or conductive line) can be formed from any suitable conductive material. Examples of suitable conductive materials include Cu, W, Al, Ag, Au, Mo, Ti, Ta, etc.

In some embodiments, a barrier layer 215A is formed on the device section 210A (e.g., between the device section 210A and the device section 220A). In some embodiments, a barrier layer 225A is formed on the device section 220A. The function of the barrier layers 215A and 225A is to prevent diffusion of the conductive material of the interconnect structures. The barrier layer 215A and/or the barrier layer 225A can be formed from any suitable dielectric material. The barrier layers 215A and 225A can have any suitable thickness. In some embodiments, the thickness of the barrier layers 215A and 225A is less than or equal to about 20 nanometers (nm).

FIG. 2B is a cross-sectional view of an optical device (“device”) 200B, according to some embodiments. As shown in FIG. 2B, the device 200B includes a substrate 202B. The substrate 202B can include any suitable material. Examples of suitable materials include Si, SiGe, glass, etc.

The device 200B can further include a device section 210B formed on the substrate 202B. The device section 210B can include a dielectric layer 212B. The dielectric layer 212B can be formed from any suitable material. In some embodiments, the dielectric layer 212B is formed from oxide. For example, the dielectric layer 212B can be formed from SiO₂. The device section 210B can further include a first metallization level of the device 200B including a first set of interconnect structures formed in the dielectric layer 212B. For example, each interconnect structure of the first set of interconnect structures can include a conductive line, such as a conductive line 218B. Each interconnect structure of the device section 210B (e.g., conductive line) can be formed from any suitable conductive material. Examples of suitable conductive materials include Cu, W, Al, Ag, Au, Mo, Ti, Ta, etc. Accordingly, in this illustrative embodiment, there are no inner cores formed within the device section 210B. In some embodiments, the substrate 202B and the device section 210B form a base structure of the device 200B.

The device 200B can further include a device section 220B formed on the device section 210B. The device section 220B can include a cladding structure 222B. The cladding structure 222B can be formed from any suitable material. In some embodiments, the cladding structure 222B is formed from oxide. For example, the cladding structure 222B can be formed from SiO₂. In some embodiments, the dielectric layer 212B is formed from the same material as the cladding structure 222B. In some embodiments, the dielectric layer 212B and the cladding structure 222B are formed from different materials. The device section 220B can further include an inner core 224B formed in the cladding structure 222B. The inner core 224B can be formed from any suitable material. More specifically, the inner core 224B can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. The device section 220B can further include a second metallization level of the device 200B including a second set of interconnect structures formed in the cladding structure 222B. For example, at least two interconnect structures of the second set of interconnect structures can each include a respective via coupled to a respective conductive line, such as a via 226B coupled to a conductive line 228B. The via 226B is also coupled to the conductive line 218B. Each interconnect structure of the second set of interconnect structures (e.g., via and/or conductive line) can be formed from any suitable conductive material. Examples of suitable conductive materials include Cu, W, Al, Ag, Au, Mo, Ti, Ta, etc.

In some embodiments, a barrier layer 215B is formed on the device section 210B (e.g., between the device section 210B and the device section 220B). In some embodiments, a barrier layer 225B is formed on the device section 220B. The function of the barrier layers 215B and 225B is to prevent diffusion of the conductive material of the interconnect structures. The barrier layer 215B and/or the barrier layer 225B can be formed from any suitable dielectric material. The barrier layers 215B and 225B can have any suitable thickness. In some embodiments, the thickness of the barrier layers 215B and 225B is less than or equal to about 20 nm.

FIG. 2C is a cross-sectional view of an optical device (“device”) 200A, according to some embodiments. As shown in FIG. 2C, device 200C includes a substrate 202C. The substrate 202C can include any suitable material. Examples of suitable materials include Si, SiGe, glass, etc.

The device 200C can further include a device section 210C formed on the substrate 202C. The device section 210C can include a dielectric layer 212C. The dielectric layer 212C can be formed from any suitable material. In some embodiments, the dielectric layer 212C is formed from oxide. For example, the dielectric layer 212C can be formed from SiO₂. The device section 210C can further include a set of inner cores of waveguides, including an inner core 213C and an inner core 214C formed in the dielectric layer 212C. The set of inner cores including the inner cores 213C and 214C can be formed from any suitable material. More specifically, at least the inner core 214C can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. In some embodiments, the inner core 213C is formed from a different material than the inner core 214C. In some embodiments, the inner core 213C is formed from Si. In some embodiments, the inner core 214C is formed from SiN. The device section 210C can further include a first metallization level of the device 200C including a first set of interconnect structures formed in the dielectric layer 212C. Each interconnect structure of the first set of interconnect structures is coupled to a respective inner core of the set of inner cores of the device section 210C. For example, each interconnect structure of the first set of interconnect structures can include a via coupled to a conductive line, such as a via 216C coupled to a conductive line 218C. The via 216C is also coupled to the inner core 213C. Each interconnect structure of the first set of interconnect structures (e.g., via and/or conductive line) can be formed from any suitable conductive material. Examples of suitable conductive materials include Cu, W, Al, Ag, Au, Mo, Ti, Ta, etc. In some embodiments, the substrate 202C and the device section 210C form a base structure of the device 200C.

The device 200C can further include a device section 220C formed on the device section 210C. The device section 220C can include a cladding structure 222C. The cladding structure 222C can be formed from any suitable material. In some embodiments, the cladding structure 222C is formed from oxide. For example, the cladding structure 222C can be formed from SiO₂. In some embodiments, the dielectric layer 212C is formed from the same material as the cladding structure 222C. In some embodiments, the dielectric layer 212C and the cladding structure 222C are formed from different materials. The device section 220C can further include an inner core 224C. The inner core 224C can be formed from any suitable material. More specifically, the inner core 224C can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. Accordingly, the inner core 224C can be formed from a different material than the inner core 213C, and the same material as the inner core 214C. The device section 220C can further include a second metallization level including a second set of interconnect structures formed in the cladding structure 222C. For example, at least two interconnect structures of the second set of interconnect structures can each include a respective via coupled to a respective conductive line, such as a via 226C coupled to a conductive line 228C. The via 226C is also coupled to the conductive line 218C. Each interconnect structure of the second set of interconnect structures (e.g., via and/or conductive line) can be formed from any suitable conductive material. Examples of suitable conductive materials include Cu, W, Al, Ag, Au, Mo, Ti, Ta, etc.

The device 200C can further include a device section 230C formed on the device section 220C. The device section 230C can include a cladding structure 232C. The cladding structure 232C can be formed from any suitable material. In some embodiments, the cladding structure 232C is formed from oxide. For example, the cladding structure 232C can be formed from SiO₂. In some embodiments, the cladding structure 232C is formed from the same material as the dielectric layer 212C and/or the cladding structure 222C. In some embodiments, the cladding structure 232C is formed from a different material than the dielectric layer 212C and/or the cladding structure 222C. The device section 230C can further include an inner core 234C. The inner core 234C can be formed from any suitable material. More specifically, the inner core 234C can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. Accordingly, the inner core 234C can be formed from a different material than the inner core 213C, and the same material as the inner core 214C and the inner core 224C. The device section 230C can further include a third metallization level of the device 200C including a third set of interconnect structures formed in the cladding structure 232C. For example, at least two interconnect structures of the third set of interconnect structures can each include a respective via coupled to a respective conductive line, such as a via 236C coupled to a conductive line 238C. The via 236C is also coupled to the conductive line 228C. Each interconnect structure of the third set of interconnect structures (e.g., via and/or conductive line) can be formed from any suitable conductive material. Examples of suitable conductive materials include Cu, W, Al, Ag, Au, Mo, Ti, Ta, etc.

As shown in FIG. 2C, the inner cores 214C, 224C and 234C can be arranged (e.g., within their respective device sections 210C, 220C and 230C), to form a staircase waveguide structure. More specifically, the staircase waveguide structure is a multi-layer staircase waveguide structure. An optical signal can be transmitted via evanescent coupling between the waveguides within the device 200C.

In some embodiments, a barrier layer 215C is formed on the device section 210C (e.g., between the device section 210C and the device section 220C). In some embodiments, a barrier layer 225C is formed on the device section 220C. In some embodiments, a barrier layer 235C is formed on the device section 230C. The function of the barrier layers 215C, 225C and 235C is to prevent diffusion of the conductive material of the interconnect structures. The barrier layer 215C, the barrier layer 225C and/or the barrier layer 235C can be formed from any suitable dielectric material. The barrier layers 215C, 225C and 235C can have any suitable thickness. In some embodiments, the thickness of the barrier layers 215C, 225C and 235C is less than or equal to about 20 nm.

FIG. 2D is a cross-sectional view of a hybrid bonded optical device (“device”) 200D, according to some embodiments. More specifically, the device 200D includes an optical device (“device”) 201D and an optical device (“device”) 203D bonded together with hybrid bonding to form the device 200D. In some embodiments, the device 201D is a PIC and the device 203D is an optical interconnect (e.g., interposer).

The device 201D can be similar to the device 201C of FIG. 2C. For example, as shown in FIG. 2D, the device 201D includes a substrate 202D-1. The substrate 202D-1 can include any suitable material. Examples of suitable materials include Si, SiGe, glass, etc.

The device 201D can further include a device section 210D formed on the substrate 202D-1. The device section 210D can include a dielectric layer 212D. The dielectric layer 212D can be formed from any suitable material. In some embodiments, the dielectric layer 212D is formed from oxide. For example, the dielectric layer 212D can be formed from SiO₂. The device section 210D can further include a set of inner cores of waveguides, including an inner core 213D and an inner core 214D formed in the dielectric layer 212D. The set of inner cores including the inner cores 213D and 214D can be formed from any suitable material. More specifically, at least the inner core 214D can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. In some embodiments, the inner core 213D is formed from a different material than the inner core 214D. In some embodiments, the inner core 213D is formed from Si. In some embodiments, the inner core 214D is formed from SiN. The device section 210D can further include a first metallization level of the device 200D including a first set of interconnect structures formed in the dielectric layer 212D. Each interconnect structure of the first set of interconnect structures is coupled to a respective inner core of the set of inner cores of the device section 210D. For example, each interconnect structure of the first set of interconnect structures can include a via coupled to a conductive line, such as a via 216D coupled to a conductive line 218D. The via 216D is also coupled to the inner core 213D. Each interconnect structure of the first set of interconnect structures (e.g., via and/or conductive line) can be formed from any suitable conductive material. Examples of suitable conductive materials include Cu, W, Al, Ag, Au, Mo, Ti, Ta, etc. In some embodiments, the substrate 202D-1 and the device section 210D form a base structure of the device 201D.

The device 201D can further include a device section 220D formed on the device section 210D. The device section 220D can include a cladding structure 222D. The cladding structure 222D can be formed from any suitable material. In some embodiments, the cladding structure 222D is formed from oxide. For example, the cladding structure 222D can be formed from SiO₂. In some embodiments, the dielectric layer 212D is formed from the same material as the cladding structure 222D. In some embodiments, the dielectric layer 212D and the cladding structure 222D are formed from different materials. The device section 220D can further include an inner core 224C. The inner core 224D can be formed from any suitable material. More specifically, the inner core 224D can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. Accordingly, the inner core 224D can be formed from a different material than the inner core 213D, and the same material as the inner core 214D. The device section 220D can further include a second metallization level of the device 200D including a second set of interconnect structures formed in the cladding structure 222D. For example, at least two interconnect structures of the second set of interconnect structures can each include a respective via coupled to a respective conductive line, such as a via 226D coupled to a conductive line 228D. The via 226D is also coupled to the conductive line 218D. Each interconnect structure of the second set of interconnect structures (e.g., via and/or conductive line) can be formed from any suitable conductive material. Examples of suitable conductive materials include Cu, W, Al, Ag, Au, Mo, Ti, Ta, etc.

The device 201D can further include a device section 230D formed on the device section 220D. The device section 230D can include a cladding structure 232D. The cladding structure 232D can be formed from any suitable material. In some embodiments, the cladding structure 232D is formed from oxide. For example, the cladding structure 232D can be formed from SiO₂. In some embodiments, the cladding structure 232D is formed from the same material as the dielectric layer 212D and/or the cladding structure 222D. In some embodiments, the cladding structure 232D is formed from a different material than the dielectric layer 212D and/or the cladding structure 222D. The device section 230D can further include an inner core 234D. The inner core 234D can be formed from any suitable material. More specifically, the inner core 234D can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. Accordingly, the inner core 234D can be formed from a different material than the inner core 213D, and the same material as the inner core 214D and the inner core 224D. The device section 230D can further include a third metallization level of the device 200D including a third set of interconnect structures formed in the cladding structure 232D. For example, at least two interconnect structures of the third set of interconnect structures can each include a respective via coupled to a respective conductive line, such as a via 236D coupled to a conductive line 238D. The via 236D is also coupled to the conductive line 228D. Each interconnect structure of the third set of interconnect structures (e.g., via and/or conductive line) can be formed from any suitable conductive material. Examples of suitable conductive materials include Cu, W, Al, Ag, Au, Mo, Ti, Ta, etc.

As further shown in FIG. 2D, the device 203D includes a substrate 202D-2. The substrate 202D-2 can include any suitable material. Examples of suitable materials include Si, SiGe, glass, etc.

The device 203D can further include a device section 240D formed on the substrate 202D-2. The device section 240D can include a cladding structure 242D. The cladding structure 242D can be formed from any suitable material. In some embodiments, the cladding structure 242D is formed from oxide. For example, the cladding structure 242D can be formed from SiO₂. The device section 240D can further include an inner core 244D formed in the cladding structure 242D. The inner core 244D can be formed from any suitable material. More specifically, the inner core 244D can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. The device section 240D can further include a fourth metallization level of the device 200D including a fourth set of interconnect structures formed in the cladding structure 242D. For example, each interconnect structure of the fourth set of interconnect structures can include a via coupled to a conductive line, such as a via 246D coupled to a conductive line 248D. The via 246D can extend from the conductive line 248D through the substrate 202D-2. Each interconnect structure of the fourth set of interconnect structures (e.g., via and/or conductive line) can be formed from any suitable conductive material. Examples of suitable conductive materials include Cu, W, Al, Ag, Au, Mo, Ti, Ta, etc. In some embodiments, the substrate 202D-D and the device section 240D form a base structure of the device 203D.

The device 203D can further include a device section 250D formed on the device section 240D. The device section 250D can include a cladding structure 252D. The cladding structure 252D can be formed from any suitable material. In some embodiments, the cladding structure 252D is formed from oxide. For example, the cladding structure 252D can be formed from SiO₂. In some embodiments, the cladding structure 252D is formed from the same material as the cladding structure 242D. In some embodiments, the cladding structure 252D and the cladding structure 242D are formed from different materials. The device section 250D can further include an inner core 254C. The inner core 254D can be formed from any suitable material. More specifically, the inner core 254D can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. The device section 250D can further include a metallization level of the deice 200D including a fifth set of interconnect structures formed in the cladding structure 252D. For example, an interconnect structures of the fifth set of interconnect structures can include a via coupled to a conductive line, such as a via 256D coupled to a conductive line 258D. The via 256D is also coupled to the conductive line 248D. Each interconnect structure of the fifth set of interconnect structures (e.g., via and/or conductive line) can be formed from any suitable conductive material. Examples of suitable conductive materials include Cu, W, Al, Ag, Au, Mo, Ti, Ta, etc.

As shown in FIG. 2D, the inner cores 214D, 224D and 234D can be arranged (e.g., within their respective device sections 210D, 220D and 230D), to form a first staircase waveguide structure. More specifically, the first staircase waveguide structure is a multi-layer staircase waveguide structure. As further shown in FIG. 2D, the inner cores 244D and 254D can be arranged (e.g., within their respective device sections 240D and 250D), to form a second staircase waveguide structure. More specifically, the second staircase waveguide structure is a multi-layer staircase waveguide structure. An optical signal can be transmitted via evanescent coupling between the waveguides within the device 200D.

In some embodiments, a barrier layer 215D is formed on the device section 210C (e.g., between the device section 210D and the device section 220D). In some embodiments, a barrier layer 225D is formed on the device section 220D. In some embodiments, a barrier layer 235D is formed on the device section 230D. In some embodiments, a barrier layer 245D is formed on the device section 240D. The function of the barrier layers 215D, 225D, 235D and 245D is to prevent diffusion of the conductive material of the interconnect structures. The barrier layer 215D, the barrier layer 225D, the barrier layer 235D and/or the barrier layer 245D can be formed from any suitable dielectric material. The barrier layers 215D, 225D, 235D and 245D can have any suitable thickness. In some embodiments, the thickness of the barrier layers 215D, 225D, 235D and 245D is less than or equal to about 20 nm.

FIG. 2E is a cross-sectional view of a hybrid bonded optical device (“device”) 200E, according to some embodiments. More specifically, the device 200E includes an optical device (“device”) 201E and an optical device (“device”) 203E bonded together with hybrid bonding to form the device 200E. In some embodiments, the device 201E is a PIC and the device 203E is an optical interconnect (e.g., interposer).

The device 201E can be similar to the device 201D of FIG. 2D. For example, as shown in FIG. 2E, the device 201E includes a substrate 202E-1. The substrate 202E-1 can include any suitable material. Examples of suitable materials include Si, SiGe, glass, etc.

The device 201E can further include a device section 210E formed on the substrate 202E-1. The device section 210E can include a dielectric layer 212E. The dielectric layer 212E can be formed from any suitable material. In some embodiments, the dielectric layer 212E is formed from oxide. For example, the dielectric layer 212E can be formed from SiO₂. The device section 210E can further include a set of inner cores of waveguides, including an inner core 213E and an inner core 214E formed in the dielectric layer 212E. The set of inner cores including the inner cores 213E and 214E can be formed from any suitable material. More specifically, at least the inner core 214E can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. In some embodiments, the inner core 213E is formed from a different material than the inner core 214E. In some embodiments, the inner core 213E is formed from Si. In some embodiments, the inner core 214E is formed from SiN. The device section 210E can further include a metallization level of the device 200E including a first set of interconnect structures formed in the dielectric layer 212E. Each interconnect structure of the first set of interconnect structures is coupled to a respective inner core of the set of inner cores of the device section 210E. For example, each interconnect structure of the first set of interconnect structures can include a via coupled to a conductive line, such as a via 216E coupled to a conductive line 218E. The via 216E is also coupled to the inner core 213E. Each interconnect structure of the first set of interconnect structures (e.g., via and/or conductive line) can be formed from any suitable conductive material. Examples of suitable conductive materials include Cu, W, Al, Ag, Au, Mo, Ti, Ta, etc. In some embodiments, the substrate 202E-1 and the device section 210E form a base structure of the device 201E.

The device 201E can further include a device section 220E formed on the device section 210E. The device section 220E can include a cladding structure 222E. The cladding structure 222E can be formed from any suitable material. In some embodiments, the cladding structure 222E is formed from oxide. For example, the cladding structure 222E can be formed from SiO₂. In some embodiments, the dielectric layer 212E is formed from the same material as the cladding structure 222E. In some embodiments, the dielectric layer 212E and the cladding structure 222E are formed from different materials. The device section 220E can further include an inner core 224C. The inner core 224E can be formed from any suitable material. More specifically, the inner core 224E can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. Accordingly, the inner core 224E can be formed from a different material than the inner core 213E, and the same material as the inner core 214E. The device section 220E can further include a second metallization level of the device 200E including a second set of interconnect structures formed in the cladding structure 222E. For example, at least two interconnect structures of the second set of interconnect structures can each include a respective via coupled to a respective conductive line, such as a via 226E coupled to a conductive line 228E. The via 226E is also coupled to the conductive line 218E. Each interconnect structure of the second set of interconnect structures (e.g., via and/or conductive line) can be formed from any suitable conductive material. Examples of suitable conductive materials include Cu, W, Al, Ag, Au, Mo, Ti, Ta, etc.

The device 201E can further include a device section 230E formed on the device section 220E. The device section 230E can include a cladding structure 232E. The cladding structure 232E can be formed from any suitable material. In some embodiments, the cladding structure 232E is formed from oxide. For example, the cladding structure 232E can be formed from SiO₂. In some embodiments, the cladding structure 232E is formed from the same material as the dielectric layer 212E and/or the cladding structure 222E. In some embodiments, the cladding structure 232E is formed from a different material than the dielectric layer 212E and/or the cladding structure 222E. The device section 230E can further include an inner core 234E. The inner core 234E can be formed from any suitable material. More specifically, the inner core 234E can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. Accordingly, the inner core 234E can be formed from a different material than the inner core 213E, and the same material as the inner core 214E and the inner core 224E. The device section 230E can further include a third metallization level of the device 200E include a third set of interconnect structures formed in the cladding structure 232E. For example, at least two interconnect structures of third set of interconnect structures can each include a respective via coupled to a respective conductive line, such as a via 236E coupled to a conductive line 238E. The via 236E is also coupled to the conductive line 228E. Each interconnect structure of the third set of interconnect structures (e.g., via and/or conductive line) can be formed from any suitable conductive material. Examples of suitable conductive materials include Cu, W, Al, Ag, Au, Mo, Ti, Ta, etc.

The device 203E can be similar to the device 203D of FIG. 2D. For example, as further shown in FIG. 2E, the device 203E includes a substrate 202E-2. The substrate 202E-2 can include any suitable material. Examples of suitable materials include Si, SiGe, glass, etc.

The device 203E can further include a device section 240E formed on the substrate 202E-2. The device section 240E can include a cladding structure 242E. The cladding structure 242E can be formed from any suitable material. In some embodiments, the cladding structure 242E is formed from oxide. For example, the cladding structure 242E can be formed from SiO₂. The device section 240E can further include an inner core 244E formed in the cladding structure 242E. The inner core 244E can be formed from any suitable material. More specifically, the inner core 244E can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. The device section 240E can further include a fourth metallization level of the device 200E including a fourth set of interconnect structures formed in the cladding structure 242E. For example, each interconnect structure of the fourth set of interconnect structures can include a via coupled to a conductive line, such as a via 246E coupled to a conductive line 248E. The via 246E can extend from the conductive line 248E through the substrate 202E-2. Each interconnect structure of the fourth set of interconnect structures (e.g., via and/or conductive line) can be formed from any suitable conductive material. Examples of suitable conductive materials include Cu, W, Al, Ag, Au, Mo, Ti, Ta, etc. In some embodiments, the substrate 202E-E and the device section 240E form a base structure of the device 203E.

The device 203E can further include a device section 250E formed on the device section 240E. The device section 250E can include a cladding structure 252E. The cladding structure 252E can be formed from any suitable material. In some embodiments, the cladding structure 252E is formed from oxide. For example, the cladding structure 252E can be formed from SiO₂. In some embodiments, the cladding structure 252E is formed from the same material as the cladding structure 242E. In some embodiments, the cladding structure 252E and the cladding structure 242E are formed from different materials. The device section 250E can further include an inner core 254C. The inner core 254E can be formed from any suitable material. More specifically, the inner core 254E can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. The device section 250E can further include a fifth metallization level of the device 200E including a fifth set of interconnect structures formed in the cladding structure 252E. For example, an interconnect structures of the fifth set of interconnect structures can include a via coupled to a conductive line, such as a via 256E coupled to a conductive line 258E. The via 256E is also coupled to the conductive line 248E. Each interconnect structure of the fifth set of interconnect structures (e.g., via and/or conductive line) can be formed from any suitable conductive material. Examples of suitable conductive materials include Cu, W, Al, Ag, Au, Mo, Ti, Ta, etc.

As shown in FIG. 2E, the inner cores 214E, 224E and 234E can be arranged (e.g., within their respective device sections 210E, 220E and 230E), to form a first staircase waveguide structure. More specifically, the first staircase waveguide structure is a multi-layer staircase waveguide structure. As further shown in FIG. 2E, the inner cores 244E and 254E can be arranged (e.g., within their respective device sections 240E and 250E), to form a second staircase waveguide structure. More specifically, the second staircase waveguide structure is a multi-layer staircase waveguide structure. An optical signal can be transmitted via evanescent coupling between the waveguides within the device 200E.

In some embodiments, a barrier layer 215E is formed on the device section 210C (e.g., between the device section 210E and the device section 220E). In some embodiments, a barrier layer 225E is formed on the device section 220E. In some embodiments, a barrier layer 235E is formed on the device section 230E. In some embodiments, a barrier layer 245E is formed on the device section 240E. The function of the barrier layers 215E, 225E, 235E and 245E is to prevent diffusion of the conductive material of the interconnect structures. The barrier layer 215E, the barrier layer 225E, the barrier layer 235E and/or the barrier layer 245E can be formed from any suitable dielectric material. The barrier layers 215E, 225E, 235E, 245E can have any suitable thickness. In some embodiments, the thickness of the barrier layers 215E, 225E, 235E and 245E is less than or equal to about 20 nm. In contrast to the device 200D of FIG. 2D, the barrier layers 215E, 225E, 245E and 255E are open (e.g., do not span through the device 200E). This can be done to provide separation from the inner cores 214E-254E to prevent coupling. The spacing can be determined based on optical signal (e.g., evanescent signal) decay.

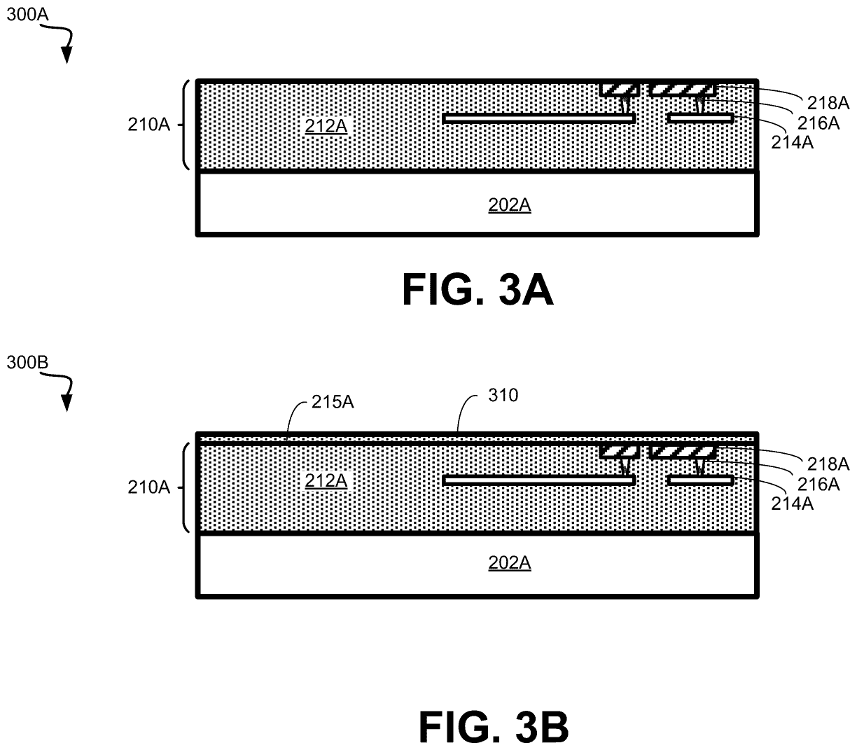

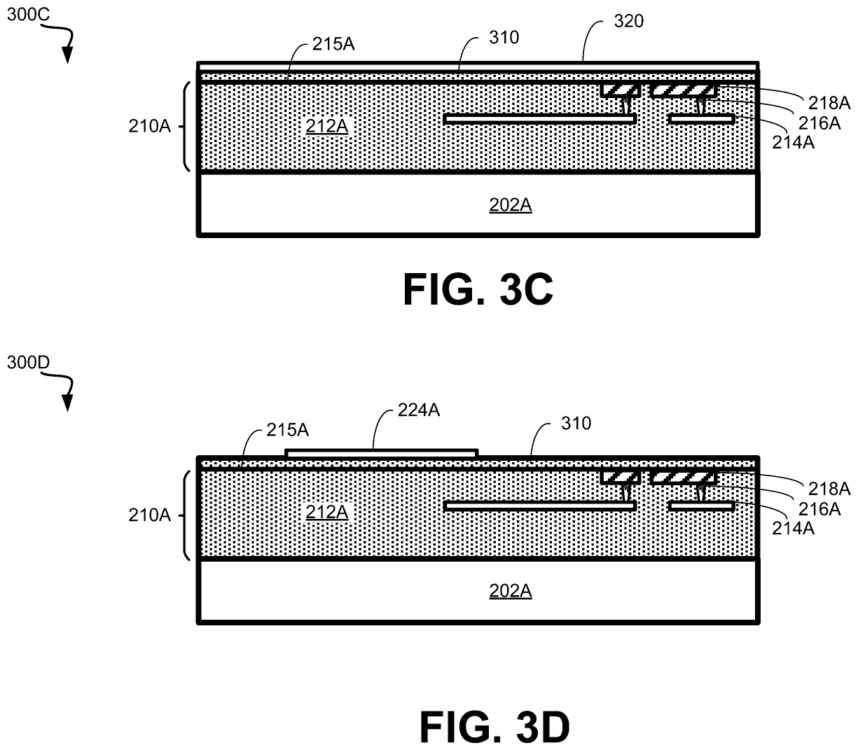

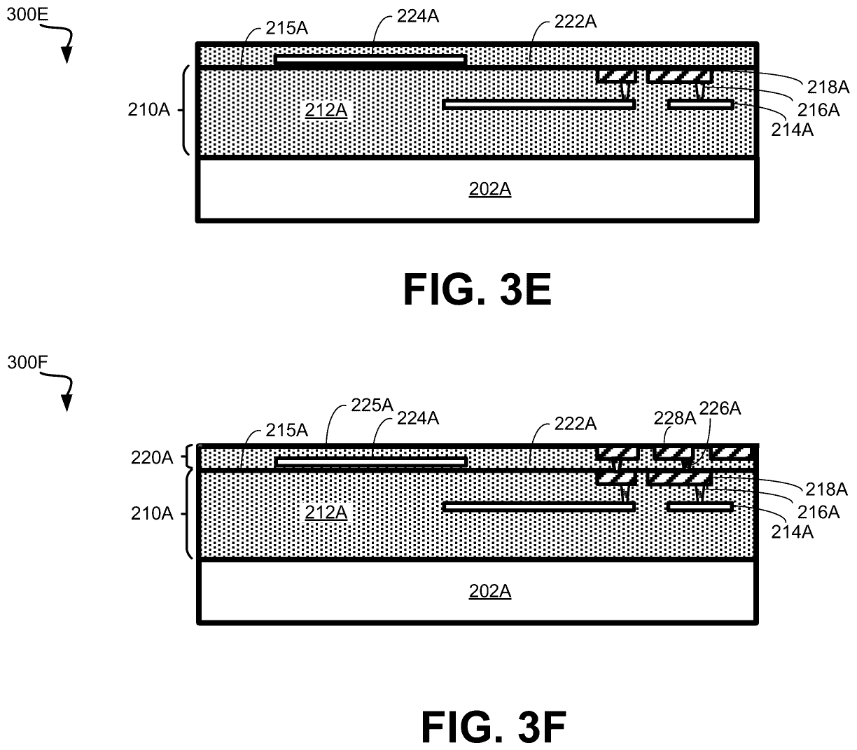

FIGS. 3A-3F are diagrams illustrating the fabrication of an example optical device with an interlayer waveguide structure, according to some embodiments.

For example, FIG. 3A is a diagram 300A showing the formation of a base structure including the substrate 202B, and the device section 210B including a first metallization level of the optical device including a first set of interconnect structures (e.g., conductive line 218A) described above with reference to FIG. 2A. In some embodiments, forming the base structure includes forming the conductive lines of the first set of interconnect structures, including conductive line 218A, using a single damascene process.

FIG. 3B is a diagram 300B shows the formation of a cladding layer 310 on the device section 210A. For example, the cladding layer 310 can be a bottom cladding layer of a cladding structure. In some embodiments, forming the cladding layer 310 includes depositing dielectric material, and planarizing the dielectric material to form the cladding layer 310 (e.g., using chemical-mechanical planarization (CMP)). The cladding layer 310 can include any suitable dielectric material. In some embodiments, the cladding layer 310 includes SiO₂. In some embodiments, the barrier layer 215A is formed on the device section 210A prior to forming the cladding layer 310.

FIG. 3C is a diagram 300C showing the formation (e.g., deposition) of an inner core material layer 320 on the cladding layer 310. The inner core material layer 320 can include any suitable inner core material. More specifically, the inner core material layer 320 can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. In some embodiments, forming the inner core material layer 320 includes depositing the inner core material (e.g., using the low loss deposition process), and planarizing the inner core material to form the inner core material layer 320 (e.g., using CMP).

FIG. 3D is a diagram 300D showing the formation of the inner core 224A from the inner core material layer 320. More specifically, a patterning loop can be performed to form the inner core 224A. For example, forming the inner core 224A from the inner core material layer 320 can include forming an etch mask on the inner core material layer 320 in a region defining the inner core 224A, and etching the inner core material layer 320 to remove exposed portions of the inner core material layer 320 and form the inner core 224A. A post-etch clean process can be performed after etching the inner core material layer 320.

FIG. 3E is a diagram 300E showing the formation of the cladding structure 222A. More specifically, forming the cladding structure 222A can include forming a second cladding layer (e.g., top cladding layer) on the inner core 224A and the cladding layer 310. In some embodiments, forming the cladding structure 222A includes depositing the second cladding layer, and planarizing the second cladding layer to form the cladding structure 222A (e.g., using CMP).

FIG. 3F is a diagram 300F showing the formation of the device section 220A. For example, forming the device section 220A can include forming the second metallization level of the optical device including the second set of interconnect structures, such as an interconnect structure including the via 226A and the conductive line 228A. In some embodiments, each interconnect structure of the second set of interconnect structures (e.g., the conductive line 228A and the via 226A) is formed by performing a dual damascene process. In some embodiments, the barrier layer 225A is formed on the device section 220A. For example, the barrier layer 225A can be formed after forming the set of interconnect structures of the device section 220A. Further details regarding FIGS. 3A-3F are described above with reference to FIGS. 2A-2E.

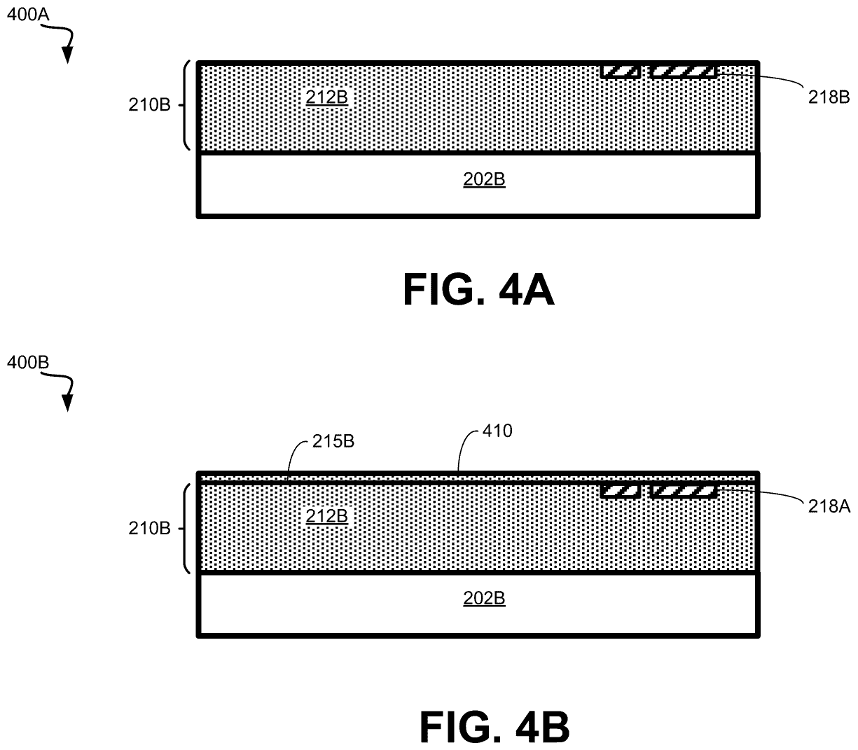

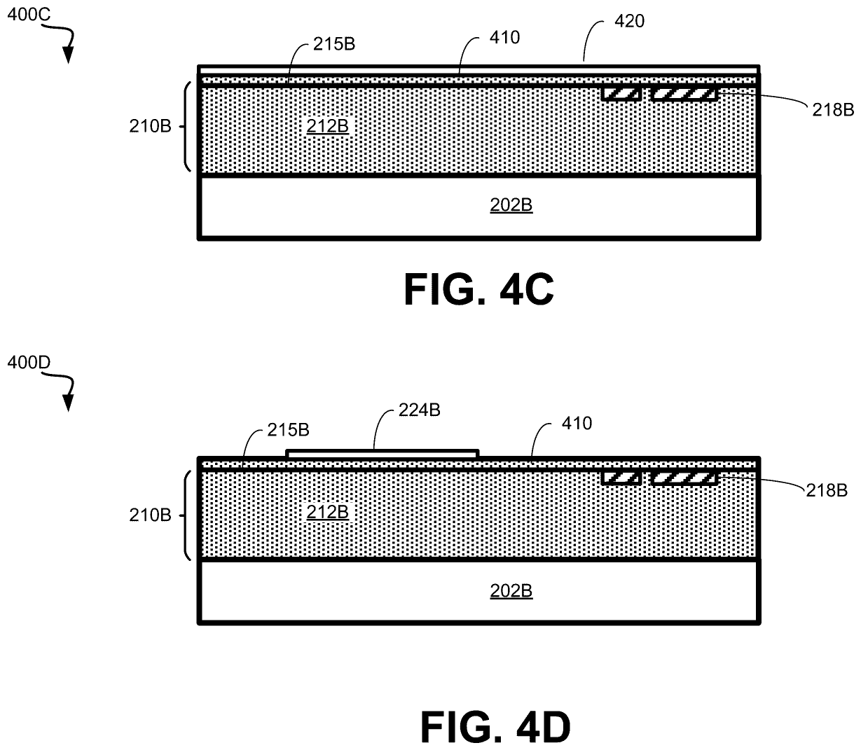

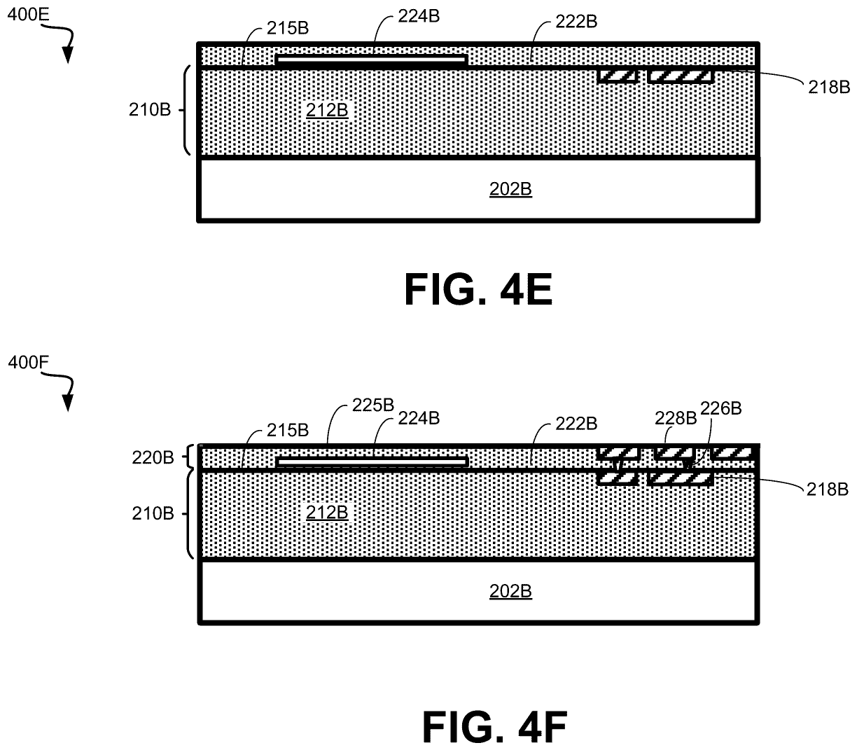

FIGS. 4A-4F are diagrams illustrating the fabrication of an example optical device with an interlayer waveguide structure, according to some embodiments.

For example, FIG. 4A is a diagram 400A showing the formation of a base structure including the substrate 202B, and the device section 210B including a first metallization level of the optical device including a first set of interconnect structures (e.g., conductive line 218B) described above with reference to FIG. 2B. In some embodiments, forming the base structure includes forming the conductive lines of the first set of interconnect structures, including conductive line 218B, using a single damascene process.

FIG. 4B is a diagram 400B showing the formation of a cladding layer 410 on the device section 210B. For example, the cladding layer 410 can be a bottom cladding layer of a cladding structure. The cladding layer 410 can include any suitable dielectric material. In some embodiments, the cladding layer 410 includes SiO₂. In some embodiments, forming the cladding layer 410 includes depositing the dielectric material, and planarizing the dielectric material to form the cladding layer 410 (e.g., using CMP). In some embodiments, the barrier layer 215B is formed on the device section 210B prior to forming the cladding layer 410.

FIG. 4C is a diagram 400C showing the formation (e.g., deposition) of an inner core material layer 420 on the cladding layer 410. The inner core material layer 420 can include any suitable inner core material. More specifically, the inner core material layer 420 can be formed by depositing an inner core material using a low loss deposition process. One example of a suitable inner core material is SiN. The low loss deposition process can be compatible with the thermal budget of the interconnect structures (e.g., performed at a temperature of less than or equal to about 400° C.). In some embodiments, the low loss deposition process is a PE-CVD process performed at a temperature of less than or equal to about 400° C. In some embodiments, forming the inner core material layer 420 includes depositing the inner core material (e.g., using the low loss deposition process), and planarizing the inner core material to form the inner core material layer 420 (e.g., using CMP).

FIG. 4D is a diagram 400D showing the formation of the inner core 224B from the inner core material layer 420. More specifically, a patterning loop can be performed to form the inner core 224B. For example, forming the inner core 224B from the inner core material layer 420 can include forming an etch mask on the inner core material layer 420 in a region defining the inner core 224B, and etching the inner core material layer 420 to remove exposed portions of the inner core material layer 420 and form the inner core 224B. A post-etch clean process can be performed after etching the inner core material layer 420.

FIG. 4E is a diagram 400E showing the formation of the cladding structure 222B. More specifically, forming the cladding structure 222B can include forming a second cladding layer (e.g., top cladding layer) on the inner core 224A and the cladding layer 310. In some embodiments, forming the cladding structure 222A includes depositing the second cladding layer, and planarizing the second cladding layer to form the cladding structure 222A (e.g., using CMP).

FIG. 4F is a diagram 400F showing the formation of the device section 220B. For example, forming the device section 220B can include forming the second metallization level including the second set of interconnect structures, such as an interconnect structure including the via 226B and the conductive line 228B. In some embodiments, each interconnect structure of the second set of interconnect structures (e.g., the conductive line 228B and the via 226B) is formed by performing a dual damascene process. In some embodiments, the barrier layer 225B is formed on the device section 220B. For example, the barrier layer 225B can be formed after forming the set of interconnect structures of the device section 220B. Further details regarding FIGS. 4A-4F are described above with reference to FIGS. 2A-3F.

In some embodiments, a system includes an optical device, such as the optical devices described above with reference to FIGS. 2A-2E. In some embodiments, the optical device is a PIC. In some embodiments, the optical device is an optical interconnect to be coupled to a PIC. In some embodiments, the system further includes a second optical device hybrid bonded to the optical device, where one of the optical device or the second optical device is a PIC, and another of the first optical device or the second optical device is an optical interconnect.

In some embodiments, the optical device includes a first metallization level including at least a first conductive line, where the first conductive line is located at a first plane, a second metallization level including at least a second conductive line, where the second conductive line is located at a second plane different from the first plane, and a first inner core of a first waveguide located at a third plane between the first plane and the second plane. In some embodiments, the first waveguide includes silicon nitride. In some embodiments, the optical device further includes a second inner core of a second waveguide located at a fourth plane, where the fourth plane is different from the first plane, the second plane and the third plane, and where the second inner core is coupled to a via of the first metallization level. In some embodiments, the optical device further includes a substrate, a first dielectric layer formed on the substrate, where at least the first conductive line is formed within the first dielectric layer, and a second dielectric layer formed on the first dielectric layer, where at least the second conductive line and the first inner core are formed within the second dielectric layer. In some embodiments, the optical device further includes a first barrier layer disposed between the first dielectric layer and the second dielectric layer, and a second barrier layer formed on the second dielectric layer.

In some embodiments, the optical device further includes a third metallization level including at least a third conductive line, where the third conductive line is located at a fourth plane, and a second inner core of a second waveguide located at a fifth plane between the second plane and the fourth plane. In some embodiments, the optical device further includes a third inner core of a third waveguide located at a sixth plane, and a fourth inner core of a fourth waveguide located at a seventh plane.

In some embodiments, the optical device further includes a third metallization level including at least a third conductive line, where the third conductive line is located at a fourth plane, and a second inner core of a second waveguide located at a fifth plane between the second plane and the fourth plane. In some embodiments, the optical device further includes a fourth metallization level including at least a fourth conductive line, where the fourth conductive line is located at a sixth plane, a third inner core of a third waveguide located at a seventh plane, a fifth metallization level including at least a fifth conductive line, where the fifth conductive line is located at an eighth plane, and a fourth inner core of a fourth waveguide located at a ninth plane between the sixth plane and the eighth plane. In some embodiments, the optical device further includes a first substrate, a first dielectric layer formed on the first substrate, where at least the first conductive line is formed within the first dielectric layer, a second dielectric layer formed on the first dielectric layer, where at least the second conductive line and the first inner core are formed within the second dielectric layer, a third dielectric layer formed on the second dielectric layer, where at least the third conductive line and the second inner core are formed within the third dielectric layer, a second substrate, a fourth dielectric layer formed on the second substrate, where at least the fourth conductive line and third inner core are formed within the fourth dielectric layer, and a fifth dielectric layer formed on the fourth dielectric layer, where at least the fifth conductive line and the fourth inner core are formed within the fifth dielectric layer. In some embodiments, the optical device further includes a first barrier layer disposed between the first dielectric layer and the second dielectric layer, a second barrier layer formed on the second dielectric layer, and a third barrier layer disposed between the fourth dielectric layer and the fifth dielectric layer.

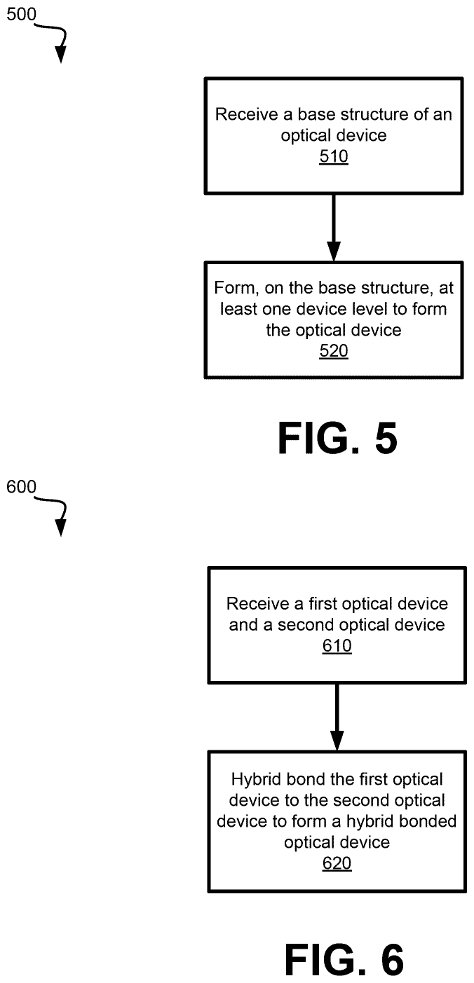

FIG. 5 is a flowchart of a method 500 to fabricate an optical device with an interlayer waveguide structure, according to some embodiments. For example, the method 500 can be used to fabricate one or more of optical devices 200A-200E described above with reference to FIGS. 2A-2E.

At block 510, a base structure of an optical device is received. For example, the optical device can be a component of co-packaged optical device. In some embodiments, the optical device is a PIC. In some embodiments, the optical device is an optical interconnect. The base structure can include a substrate, and a first device level formed on the substrate. The first device level can include a first metallization level of the optical device formed within a dielectric layer. The first metallization level can include at least one interconnect structure (e.g., conductive line coupled to a via). In some embodiments, the first device level further includes an inner core of a waveguide formed within the dielectric layer and coupled to the at least one interconnect structure (e.g., to the via).

At block 520, at least one device level is formed on the base structure to form the optical device. The at least one device level can include a second device level. Each device level can include an inner core of a waveguide and a metallization level formed within a cladding structure of the waveguide. Each metallization level can include at least one interconnect structure (e.g., conductive line coupled to a via). In some embodiments, forming a device level includes forming an inner core using a deposition process performed at a temperature of less than or equal to about 400° C. More specifically, the deposition process can be performed to deposit an inner core material (e.g., SiN), and the inner core can be patterned from the inner core material. The deposition process can be a low loss deposition process that is compatible with the thermal budget of the interconnect structures (e.g., performed at a temperature of less than or equal to about 400° C.). In some embodiments, the deposition process is a PE-CVD process performed at a temperature of less than or equal to about 400° C. In some embodiments, a device level is formed on a barrier layer, and forming the device level further includes forming a barrier layer on the device level.

In some embodiments, the at least one device level formed on the base structure is a single device level. Further details regarding forming a single device level on the base structure are described above with reference to FIGS. 2A-2B and 3A-4F.

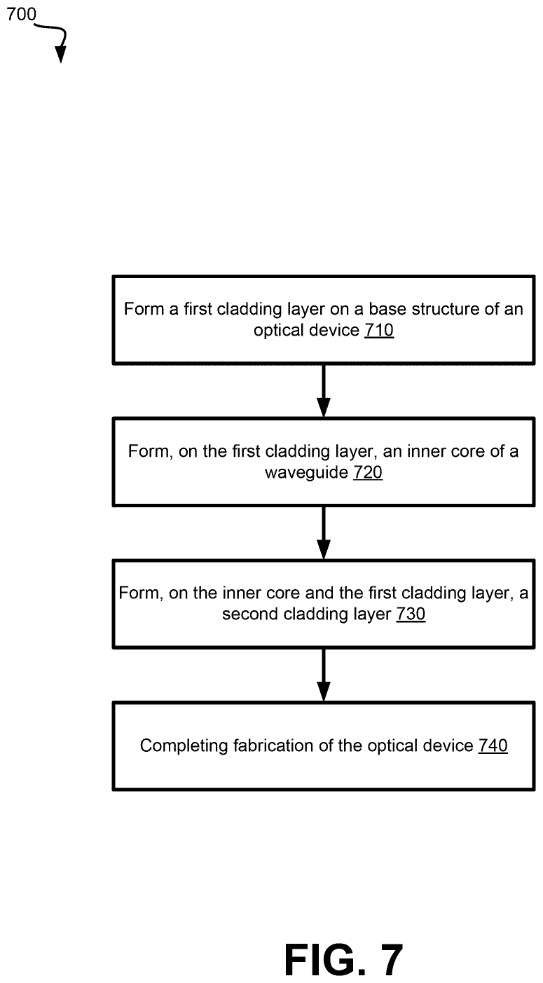

In some embodiments, the at least one device level formed on the base structure includes a plurality of device levels. The inner cores of the plurality of device levels (and the base structure) can be arranged to form a staircase waveguide structure. Further details regarding forming device levels are described above with reference to FIGS. 2C-2E and will now be described below with reference to FIG. 7.

FIG. 6 is a flowchart of a method 600 to fabricate a hybrid bonded optical device with an interlayer waveguide structure, according to some embodiments.

At block 610, a first optical device and a second optical device are received. For example, the first optical device and/or the second optical device can be similar to the optical device formed by method 500 of FIG. 5. In some embodiments, first the optical device is a PIC or an optical interconnect. In some embodiments, the second optical device is an optical interconnect or a PIC. For example, the first optical device can be similar to the device 201D of FIG. 2D or the device 201E of FIG. 2E, and the second optical device can be similar to the device 203D of FIG. 2D or the device 203E of FIG. 2E.

At block 620, the first optical device is hybrid bonded to the second optical device to form a hybrid bonded optical device. For example, the hybrid bonded optical device can be similar to the hybrid bonded optical devices 200D-200E described above with reference to FIGS. 2D-2E. Further details regarding blocks 610-620 are described above with reference to FIGS. 2A-5 and will now be described below with reference to FIG. 7.

FIG. 7 is a flowchart of a method 700 to fabricate at least a portion of an optical device, according to some embodiments. For example, the method 700 can be used to fabricate one or more of the optical devices 200A-200E described above with reference to FIGS. 2A-2E.

At block 710, a first cladding layer is formed on a base structure of an optical device. The first cladding layer can include any suitable dielectric material (e.g., SiO₂). The base structure can be similar to the base structure described above with reference to FIGS. 2A-5. In some embodiments, forming the first cladding layer includes depositing the dielectric material on the initial metallization level, and planarizing the dielectric material to form the first cladding layer. For example, the first cladding layer can be a bottom cladding layer.

At block 720, an inner core of a waveguide is formed on the first cladding layer. For example, forming the inner core can include depositing an inner core material (e.g., SiN) on the first cladding layer using a deposition process, and patterning the inner core from the inner core material (e.g., etching the inner core material using an etch mask). More specifically, the deposition process can be a low loss deposition process is compatible with the thermal budget of the interconnect structures. In some embodiments, the deposition process is performed at a temperature of less than or equal to about 400° C. In some embodiments, the deposition process is a PE-CVD process performed at a temperature of less than or equal to about 400° C.

At block 730, a second cladding layer is formed on the inner core and the first cladding layer. The second cladding layer can include any suitable dielectric material (e.g., SiO₂). In some embodiments, forming the second cladding layer includes depositing the dielectric material on the inner core and the first cladding layer, and planarizing the dielectric material to form the second cladding layer. For example, the second cladding layer can be a top cladding layer. The first cladding layer and the second cladding layer can collectively form a cladding structure of the waveguide.

At block 740, fabrication of the optical device is completed. For example, completing fabrication of the optical device can include forming, within the cladding structure, a second metallization level of the optical device. Forming the second metallization level can include forming a set of interconnect structures within the cladding structure. In some embodiments, the set of interconnect structures of the second metallization level is formed using a dual damascene process.

In some embodiments, the first cladding layer is formed on a first barrier layer formed on the base structure, and completing fabrication of the optical device further includes forming a second barrier layer on the cladding structure and the second metallization level. In some embodiments, each barrier layer has a thickness of less than or equal to about 20 nm.

In some embodiments, completing fabrication of the optical device further includes forming, on the second metallization level and the cladding structure, a third cladding layer, forming a second inner core of a second waveguide on the third cladding layer, forming, on the second inner core and the third cladding layer, a fourth cladding layer to form a second cladding structure of the second waveguide, and forming, within the second cladding structure, a third metallization level of the optical device. Further details regarding operations 710-740 are described above with reference to FIGS. 2A-6.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within +10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
an optical device comprising:
a first device section corresponding to a first metallization level comprising at least a first conductive line located at a first plane;
a second device section corresponding to a second metallization level comprising at least a second conductive line located at a second plane different from the first plane; and
a first waveguide comprising a first inner core located at a third plane between the first plane and the second plane.

2. The system of claim 1, wherein the optical device further comprises a second waveguide comprising a second inner core located at a fourth plane different from the first plane, the second plane, and the third plane, and wherein the second inner core is coupled to a via of the first metallization level.

3. The system of claim 1, wherein the optical device further comprises:
a substrate;
a first dielectric layer formed on the substrate, wherein at least the first conductive line is formed within the first dielectric layer; and
a second dielectric layer formed on the first dielectric layer, wherein at least the second conductive line and the first inner core are formed within the second dielectric layer.

4. The system of claim 3, wherein the optical device further comprises:
a first barrier layer disposed between the first dielectric layer and the second dielectric layer; and
a second barrier layer formed on the second dielectric layer.

5. The system of claim 1, wherein the optical device further comprises:
a third device section corresponding to a third metallization level comprising at least a third conductive line located at a fourth plane; and
a second inner core of a second waveguide, wherein the second inner core is located at a fifth plane between the second plane and the fourth plane.

6. The system of claim 5, wherein the optical device further comprises:
a third waveguide comprising a third inner core located at a sixth plane; and
a fourth waveguide comprising a fourth inner core located at a seventh plane.

7. The system of claim 5, wherein the optical device further comprises:
a fourth device section corresponding to a fourth metallization level comprising at least a fourth conductive line located at a sixth plane;
a third waveguide comprising a third inner core located at a seventh plane;
a fifth device section corresponding to a fifth metallization level comprising at least a fifth conductive line, wherein the fifth conductive line is located at an eighth plane; and
a fourth waveguide comprising a fourth inner core located at a ninth plane between the sixth plane and the eighth plane.

8. The system of claim 7, wherein the optical device further comprises:
a first substrate;
a first dielectric layer formed on the first substrate, wherein at least the first conductive line is formed within the first dielectric layer;
a second dielectric layer formed on the first dielectric layer, wherein at least the second conductive line and the first inner core are formed within the second dielectric layer;
a third dielectric layer formed on the second dielectric layer, wherein at least the third conductive line and the second inner core are formed within the third dielectric layer;
a second substrate;
a fourth dielectric layer formed on the second substrate, wherein at least the fourth conductive line and the third inner core are formed within the fourth dielectric layer; and
a fifth dielectric layer formed on the fourth dielectric layer, wherein at least the fifth conductive line and the fourth inner core are formed within the fifth dielectric layer.

9. The system of claim 8, wherein the optical device further comprises:
a first barrier layer disposed between the first dielectric layer and the second dielectric layer;
a second barrier layer formed on the second dielectric layer; and
a third barrier layer disposed between the fourth dielectric layer and the fifth dielectric layer.

10. The system of claim 1, wherein the first inner core comprises silicon nitride.

11. The system of claim 1, wherein the optical device is one of: a photonic integrated circuit, or an optical interconnect to be coupled to a photonic integrated circuit.

12. The system of claim 1, further comprising a second optical device hybrid bonded to the optical device, wherein one of the optical device or the second optical device is a photonic integrated circuit, and wherein another of the optical device or the second optical device is an optical interconnect.

13. A method comprising:
forming, on a base structure of an optical device, a first cladding layer, wherein the base structure comprises a first device section corresponding to a first metallization level of the optical device;
forming, on the first cladding layer, a first inner core of a first waveguide;
forming, on the first inner core and the first cladding layer, a second cladding layer to form a first cladding structure of the first waveguide; and
forming, within the first cladding structure, a second device section corresponding to a second metallization level of the optical device.

14. The method of claim 13, wherein forming the second device section comprises forming the first waveguide using a deposition process performed at a temperature of less than or equal to about 400° C.

15. The method of claim 14, wherein the deposition process comprises a plasma-enhanced chemical vapor deposition (PE-CVD) process.

16. The method of claim 13, wherein the first cladding layer is formed on a first barrier layer formed on the base structure, and wherein the method further comprises forming a second barrier layer on the first cladding structure and the second device section.

17. The method of claim 13, further comprising:
forming, on the second device section and the first cladding structure, a third cladding layer;
forming, on the third cladding layer, a second inner core of a second waveguide;
forming, on the second inner core and the third cladding layer, a fourth cladding layer to form a second cladding structure of the second waveguide; and
forming, within the second cladding structure, a third device section corresponding to a third metallization level of the optical device.

18. The method of claim 17, wherein the base structure further comprises:
a third inner core of a third waveguide, wherein the third inner core is coupled to a first interconnect structure of the first metallization level; and
a fourth inner core of a fourth waveguide, wherein the fourth inner core is disposed between the first inner core and the second inner core, and wherein the first inner core, the second inner core, the third inner core and the fourth inner core are arranged to form a staircase waveguide structure.

19. The method of claim 18, further comprising bonding the optical device to a second optical device to form a hybrid bonded optical device.

20. The method of claim 13, wherein the first inner core comprises silicon nitride.
